(19) United States
(12) Patent Application Publication
(10) Pub. No.: US 2019/0358121 A1
(43) Pub. Date: Nov. 28, 2019

(54) ACUPRESSURE HEALTH CARE PANTS HAVING FAR INFRARED AND NEGATIVE ION DOUBLE EFFECT ENERGY

(71) Applicant: HOMEWAY TECHNOLOGY CO., LTD., Tainan City (TW)

(72) Inventor: Chin-Hsing HSIEH, Tainan City (TW)

(21) Appl. No.: 16/111,997

(22) Filed: Aug. 24, 2018

(30) Foreign Application Priority Data
May 28, 2018 (TW) 107118104

(51) Int. Cl. A61H 39/04; A41D 1/06; A41D 31/00

(52) U.S. Cl. CPC A61H 39/04; A41D 1/06; A41D 31/00; A41D 2400/32; A41D 2500/10; A61H 2201/164; A41D 2400/34; A41D 2400/36; A41D 2400/10; A61H 2201/165

(57) ABSTRACT

A pair of acupressure health care pants for applying acupressure to predetermined acupoints on a lower body of a user includes a pants body and an acupressure unit. The pants body is configured to elastically and tightly press against the lower body of the user when the pair of acupressure health care pants are worn by the user, and has a fiber base material mixed with a plurality of far infrared particles and negative ion particles. The acupressure unit includes a plurality of acupressure protrusions protruding from the fiber base material into an interior of the pants body and configured to apply acupressure to the lower body of the user at positions respectively corresponding to the predetermined acupoints.

### CROSS-REFERENCE TO RELATED APPLICATION

This application claims priority to Taiwanese Application No. 107118104, filed on May 28, 2018.

### FIELD

The disclosure relates to a pair of high waist pants, more particularly to a pair of acupressure health care pants having far infrared and negative ion double effect energy that can apply acupressure to the acupoints of the lower body of a user.

### BACKGROUND

Due to the impact of gravity, the human body's blood tends to flow from top down toward the two feet, and is pushed back to the heart by contraction of the muscles of the feet, so that the feet are also called the second heart. Some people will choose to wear tights to elastically tighten their feet, hips and buttocks to promote blood circulation.

Although the conventional tights can achieve its intended purpose, since the tights are generally made from woven elastic yarns and does not have energy particles, the conventional tights have a limited effect of improving the blood circulation and the physical fitness during exercise. On the other hand, in the theoretical basis of traditional Chinese medicine, the human body has multiple meridians, and the specific points in the meridians at which the body's blood is concentrated, transferred or accessed are often called acupoints. Because the position of each acupoint is different, each acupoint has its own function. There are many well-known acupoints in the lower body of the human body, such as Huantiao, Fengshi, Zhongdu and Xiyangguan located on the gallbladder meridian; Shenque and Guanyuan located on the conception vessel; Mingmen located on the governing vessel; Zusanli located on the stomach meridian; Weizhong located on the bladder meridian; Sanyinjiao located on the spleen meridian; and Yong quan located on the kidney meridian. These acupoints are very important for human health care. If these acupoints can be frequently pressed and rubbed, it will greatly benefit the health and wellness of the human body. Thus, if the structure of the conventional tights can be improved such that the tights can apply acupressure on these acupoints during wear thereof, the economic value and health care function thereof may be greatly enhanced.

### SUMMARY

Therefore, an object of the present disclosure is to provide a pair of acupressure health care pants that is capable of alleviating at least one of the drawbacks of the prior art.

According to this disclosure, a pair of acupressure health care pants for applying acupressure to predetermined acupoints on a lower body of a user includes a pants body and an acupressure unit. The pants body is configured to elastically and tightly press against the lower body of the user when the pair of acupressure health care pants are worn by the user, and has a fiber base material mixed with a plurality of far infrared particles and negative ion particles. The acupressure unit includes a plurality of acupressure protrusions protruding from the fiber base material into an interior of the pants body and configured to apply acupressure to the lower body of the user at positions respectively corresponding to the predetermined acupoints.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a pair of acupressure health care pants according to the embodiment of this disclosure;

FIG. 2 is another perspective view of the embodiment in a state of use; and

FIG. 3 is a sectional view taken along line III-III of FIG. 1.

### DETAILED DESCRIPTION

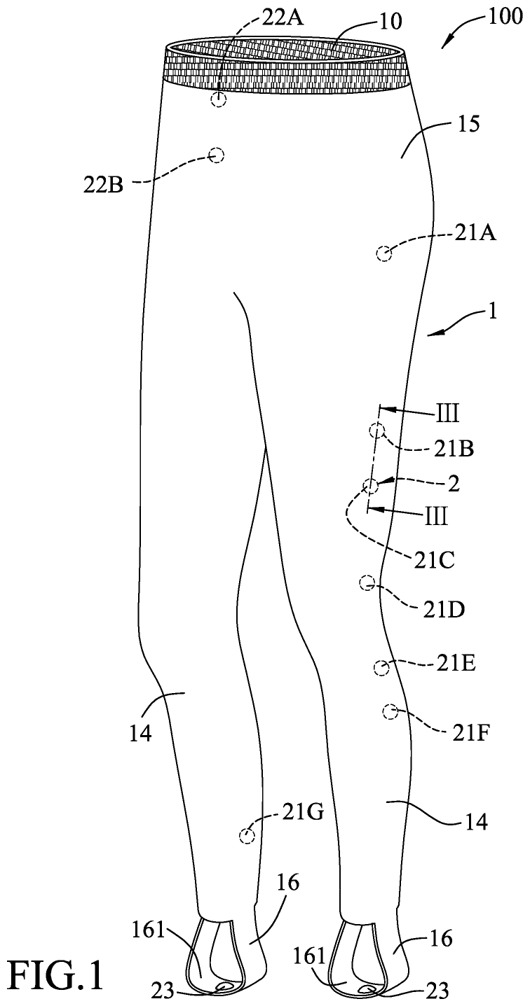

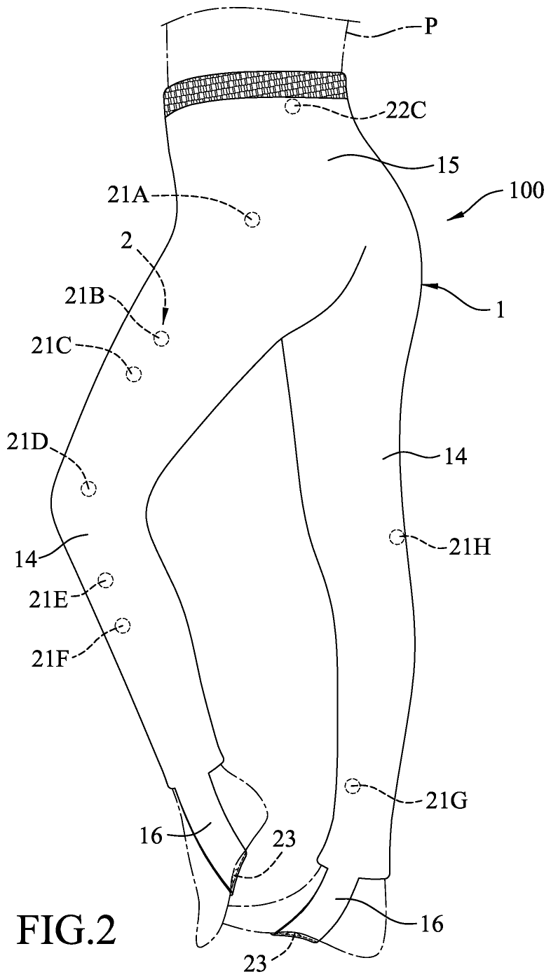

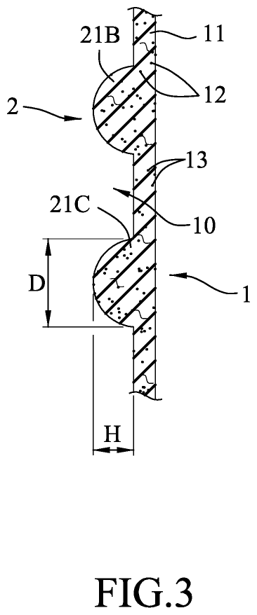

Referring to FIGS. 1 to 3, a pair of acupressure health care pants 100 according to an embodiment of the present disclosure is shown to include a pants body 1 and an acupressure unit 2.

The pants body 1 is made by weaving far infrared negative ion double-effect yarns with the blended yarn of peptide protein fibers and elastic fibers. In other words, the pants body 1 has a fiber base material 11 mixed with a plurality of far infrared particles 12 and a plurality of negative ion particles 13. If necessary, nano silver particles having a bactericidal effect may also be mixed with the fiber base material 11. The chemical composition of the far infrared particles 12 is 30% Zn₂O, 30% Al₂O₃, 30% TiO₂, and 10% Sb₂O₃. The far infrared particles 12 can emit far infrared light waves to resonate water molecules in the cells so as to stimulate cell activation and promote growth. That is, they can have the following effects: promote blood circulation and metabolism, activate cell tissues, discharge wastes and toxins from the body, balance the body's pH, increase oxygen content in the body to enhance immunity, dry quickly the perspiration, remove odor, prevent mildew, kill bacteria, and store heat and preserve warm during winter. Thus, human health can be improved.

The negative ion particle 13 is usually a ring-shaped silicate mineral containing borons of Al, Na, Fe, Mg and Li. The main components are trigonal silicate, a small amount of iron oxide, aluminum oxide, magnesium, and organic matter. The negative ion particle 13 has the characteristics of adsorption, decomposition of hazardous substances, and purifying air. The nano silver particle has a bactericidal function, and can bind to the cell wall or cell membrane of the bacteria so as to enter an interior of the cell body and block the metabolism of the cell, causing it to lose its activity and die naturally.

The pants body 1 includes a hip portion 15 for covering the lower abdomen of a user (P), two leg portions 14 extending from the hip portion 15 for respectively covering two legs of the user (P), and two foot stirrups 16 respectively provided on bottom ends of the leg portions 14. Each leg portion 14 has an upper leg region, a lower leg region and a knee region between the upper and lower leg regions. Each foot stirrup 16 is worn under the arch of the foot of the user (P) to hold the bottom end of the respective leg portion 14 in place.

The acupressure unit 2 is integrally formed as one piece with the pants body 1, and includes a plurality of acupressure protrusions (21A-21H, 22A-22C, 23) protruding from the fiber base material 11 into an interior 10 of the pants body 1 and configured to apply acupressure to the lower body of the user (P) at positions respectively corresponding to predetermined acupoints on the lower body of the user (P). In this embodiment, the acupressure unit 2 may include two sets of first acupressure protrusions (21A-21H) disposed respectively and symmetrically on the leg portions 14, three second acupressure protrusions (22A, 22B, 22C) disposed on the hip portion 15, and two third acupressure protrusions 23 respectively disposed on inner surfaces 161 of the foot stirrups 16. Manufacture of the health care pants 100 uses a knitting machine in combination with a computer for controlling the knitting machine. That is, a design diagram of the pants 100 is input into the computer. With the computer controlling the knitting machine, a one-piece body of the pants 100 can be automatically formed, and there is no need for a second manufacturing process. This technique of combining the knitting machine with the computer is known in the art. Further, the first, second and third acupressure protrusions (21A-21H, 22A-22C, 23) are formed by thickening the yarns during the manufacturing process. Hence, the manufacturing process of the pants 100 is relatively easy.

There is no special restriction on the shape and the protruding thickness of the first, second and third acupressure protrusions (21A-21H, 22A-22C, 23), as long as they protrude from the fiber base material 11 into the interior 10 of the pants body 1, any shape thereof is acceptable. In this embodiment, each of the first, second and third acupressure protrusions (21A-21H, 22A-22C, 23) has a protruding curved shape having a protruding thickness (H) of 2 to 4 mm, preferably 3 mm, and a diameter (D) of 4 to 10 mm, preferably 5 mm.

Since the two sets of first acupressure protrusions (2A-2H) are disposed symmetrically and respectively on the leg portions 14, only one set of first acupressure protrusions (2A-2H) disposed on one of the leg portions 14 will be described hereinafter for the sake of brevity.

The first acupressure protrusions (21A-21D) are located on an outer side (or left side) of the upper leg region of the leg portion 14 and are spaced apart from each other in a top-to-bottom direction. The first acupressure protrusions (21A-21D) are respectively configured to apply acupressure to the upper leg region of the leg portion 14 at positions corresponding to the Huantiao, Fengshi, Zhongdu and Xiyangguan acupoints located on the gallbladder meridian. By applying acupressure to these acupoints, the effects of detoxifying and slimming the user's body may be achieved. If necessary, these acupoints maybe lightly hit or strike by the user (P) to further enhance its effect.

The first acupressure protrusion (21E) is located on an outer side (or left side) of the lower leg region of the leg portion 14 and is configured to apply acupressure to the lower leg region of the leg portion 14 at a position corresponding to the Yanglingquan acupoint which is roughly below the Xiyangguan acupoint and which is also known as tendon relaxation and meridian activation acupoint. By applying acupressure to the Yanglingquan acupoint, the effect of relieving the pain around the shoulders and the nerve pain between the ribs may be achieved. If necessary, this acupoint may be lightly press and rub by the user (P) to further enhance its effect. The first acupressure protrusion (21F) is roughly located three inches below the knee region of the leg portion 14 at an outer side (or left side) thereof, and is configured to apply acupressure to the knee region of the leg portion 14 at a position corresponding to the Zusanli acupoint, which is also known as all-around acupoint, so as to achieve the effect of preventing cardiovascular and cerebrovascular diseases, and the effect of relieving work stress, fatigue and chronic gastrointestinal diseases. If necessary, this acupoint may be lightly press by the user (P) to further enhance its effect.

The first acupressure protrusion (21G) is located on an inner side (or right side) of the lower leg region of the leg portion 14 three inches above the bottom end thereof, and is configured to apply acupres sure to the lower leg region of the leg portion 14 at a position corresponding to the Sanyinjiao acupoint, which is also known as the nourishing and beautifying acupoint. By applying acupressure to the Sanyinjiao acupoint, the effects of removing blockage in the body, caring of the uterus and overies, regulating menstruation, removing wrinkles and pimples, and treatment of skin allergies, inflammation and eczema may be achieved. If necessary, this acupoint may be lightly press and rub by the user (P) to further enhance its effect. The first acupressure protrusion (21H) is located at the back of the knee region of the leg portion 14, and is configured to apply acupressure to the knee region of the leg portion 14 at a position corresponding to the Weizhong acupoint which is located at the midpoint of the back of the knee, and which is also known as the acupoint for relieving lower back pain. By applying acupressure to the Weizhong acupoint, the effect of smoothly circulating the blood at the lower back may be achieved. If necessary, this acupoint may be lightly press by the user (P) to further enhance its effect.

The second acupressure protrusion (22A) is located on a front part of the hip portion 15 at a position corresponding to the navel, and is configured to apply acupressure to the front part of the hip portion 15 at a position corresponding to the Shenque acupoint which belongs to the conception vessel. Since the fetus in the mother's body absorbs nutrients and oxygen of the mother through the umbilical cord, therefore, in the traditional Chinese medicine theory, the umbilical cord communicates with the five internal organs, and is the gate of the essential qi or energy. By applying acupressure to the Shenque acupoint, the effect of staying young may be achieved. If necessary, this acupoint may be lightly press and rub by the user (P) to further enhance its effect. The second acupressure protrusion (22B) is located below the second acupressure protrusion (22A), and is configured to apply acupressure to the front part of the hip portion 15 at a position corresponding to the Guanyuan acupoint which is located three inches below the Shengue acupoint. By applying acupressure to this acupoint, the effect of invigorating the kidney qi and the effect of anti-aging may be achieved. If necessary, this acupoint may be lightly press and rub by the user (P) to further enhance its effect. The second acupressure protrusion (22C) is located on a rear part of the hip portion 15, is opposite to the second acupressure protrusion (22A), and is configured to apply acupressure to the rear part of the hip portion 15 at a position corresponding to the Mingmen acupoint. By applying acupressure to this acupoint, the effect of strengthening the kidney and the effect of treating sexual dysfunction, irregular menstruation, chronic enteritis and waist disease may be achieved. If necessary, this acupoint may be lightly press and rub by the user (P) to further enhance its effect.

Each third acupressure protrusion 23 is configured to apply acupressure to the bottom of the foot of the user (P) at a position corresponding to the Yong quan acupoint which is located on the sole of the foot at the indentation near the front part, between the second and third metatarsal bones, one-third the distance from the webs of the toes to the heel, and at the beginning of the kidney meridian. The Yongquan acupoint is also known as a calming of the spirit acupoint. By applying acupressure to this acupoint, it may not only be beneficial for the spleen and the blood, but also it may aid in sleeping. If necessary, this acupoint may be lightly press and rub by the user (P) to further enhance its effect.

Since the pants body 1 is made of an elastic material, when the pair of health care pants 100 are worn by the user (P), it elastically and tightly presses against the legs and the lower abdomen of the user (P), and the first, second and third acupressure protrusions (21A-21H, 22A-22C, 23) of the acupressure unit 2 respectively correspond to the important acupoints of the lower body of the user (P) and may apply acupressure thereto for providing a therapeutic benefit to the user (P). Further, the pants body 1 has the far-infrared particles 12 and the negative ion particles 13 which can generate energy waves. Thus, through the presence of the far-infrared particles 12, the negative ion particles 13, and the first to third acupressure protrusions (21A-21H, 22A-22C, 23) on the pants body 1, the circulation of blood, the physical fitness during exercise and other therapeutic benefits maybe achieved during wear of the health care pants 100.

It should be noted herein that, since the first to third acupressure protrusions (21A-21H, 22A-22C, 23) of the acupressure unit 2 respectively correspond to the important acupoints of the lower body of the user (P) and protrude into the interior 10 of the pants body 1 to apply acupressure to these important acupoints, not only are the acupoints can be pressed accurately, the forces applied thereto are lighter as compared to manually pressing the acupoints.

Further, the numbers and dispositions of the first to third acupressure protrusions (21A-21H, 22A-22C, 23) of the acupressure unit 2 are not limited to what is disclosed in this embodiment. The numbers thereof may be increased or decreased, and their dispositions may be varied according to the requirements. That is, the acupressure protrusions (21A-21H, 22A-22C, 23) on the pants body 1 of this disclosure may be disposed at positions corresponding to other acupoints on the lower body of the user (P).

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pair of acupressure health care pants for applying acupressure to predetermined acupoints on a lower body of a user, comprising:
a pants body configured to elastically and tightly press against the lower body of the user when said pair of acupressure health care pants are worn by the user, and having a fiber base material mixed with a plurality of far infrared particles and negative ion particles; and
an acupressure unit including a plurality of acupressure protrusions protruding from said fiber base material into an interior of said pants body and configured to apply acupressure to the lower body of the user at positions respectively corresponding to the predetermined acupoints.

2. The acupressure health care pants as claimed in claim 1, wherein:
said pants body includes a hip portion for covering a lower abdomen of the user, and two leg portions extending from said hip portion for respectively covering two legs of the user; and
said acupressure unit includes a plurality of first acupressure protrusions provided on said leg portions, and a plurality of second acupressure protrusions provided on said hip portion.

3. The acupressure health care pants as claimed in claim 2, wherein said pants body further includes two foot stirrups respectively provided on bottom ends of said leg portions, and said acupressure unit further includes two third acupressure protrusions each of which is disposed on an inner surface of a respective one of said foot stirrups and each of which is configured to apply acupressure on the bottom of the foot of the user at a position corresponding to one of the predetermined acupoints.

4. The acupressure health care pantsas claimed in claim 2, wherein each of said first and second acupressure protrusions has a protruding curved shape having a protruding thickness of 2 to 4 mm, and a diameter of 4 to 10 mm.

5. The acupressure health care pantsas claimed in claim 3, wherein each of said first and second acupressure protrusions has a protruding curved shape having a protruding thickness of 2 to 4 mm, and a diameter of 4 to 10 mm.
